(19) United States
(12) Patent Application Publication
(10) Pub. No.: US 2025/0066392 A1
(43) Pub. Date: Feb. 27, 2025

(54) Extension-Functionalization Strategy for Water-Harvesting MOFs

(71) Applicant: The Regents of the University of California, Oakland, CA (US)

(72) Inventors: Omar M. Yaghi, Berkeley, CA (US); Nikita Hanikel, Berkeley, CA (US); Daria V. Kurandina, Berkeley, CA (US)

(21) Appl. No.: 18/943,182

(22) Filed: Nov. 11, 2024

Related U.S. Application Data
(63) Continuation-in-part of application No. PCT/US2023/065641, filed on Apr. 11, 2023.
(60) Provisional application No. 63/480,518, filed on Jan. 19, 2023.
(60) Provisional application No. 63/342,060, filed on May 13, 2022.

(51) Int. Cl. C07F 5/06; B01J 20/22

(52) U.S. Cl. CPC C07F 5/069; B01J 20/226

(57) ABSTRACT

Novel water-stable metalorganic framework (MOF) composition with linker extension/functionalization provide higher water uptake at low relative humidity.

This invention was made with government support under grant number HR0011-21-C-002 from the Department of Defense Advanced Research Projects Agency. The government has certain rights in the invention.

### INTRODUCTION

Nearly one-third of the global population lives in arid areas with limited access to clean water.¹ Therefore, innovative solutions are urgently wanted to address this global water crisis affecting millions of people. Atmospheric water accounts for 10¹⁸ cubic meters, that constitutes 3% of the total fresh water accessible on our planet.² Present everywhere and anytime, this water, once harvested, could help to ease the global water crisis.³

Metal-organic frameworks (MOFs) have emerged as promising materials for atmospheric water capture.^{4,5} Several MOFs have been shown to exhibit three major characteristics for this purpose: 1) high water stability, 2) steep water uptake step at low relative humidity (RH) (<40%) and 3) low regeneration energy for recycling purposes. Importantly, unlike other porous materials,⁶ MOFs demonstrate a high potential for tunability of surface area, pore volume, and pore structure via modifications at the molecular level. MOFs demonstrate a high potential for tunability of surface area, pore volume, and pore structure via modifications at the molecular level, which directly influences their water sorption properties Enhancement of water uptake at low RH while retaining all the above-mentioned characteristics has been a long-standing problem in the research on water-harvesting MOFs.

In addition to MOFs a diverse range of materials such as silica gel, porous polymers, and zeolites have been tested for their water sorption properties.¹⁰ However, all of them suffer from drawbacks that prevent their usage in water-harvesting devices. Thus, zeolites, although showing a steep water uptake at low pH, require enormous amounts of energy for regeneration. Otherwise, they experience structure poisoning through permanent water enclosure in their pores that negatively impacts their efficacy. The water sorption isotherm profiles of silica gel and porous polymers lack steepness that results in a low working capacity of these materials.

Among MOFs, only a few examples have been shown to demonstrate the desirable properties for water-harvesting applications.¹¹ The moisture sensitivity and hydrophobicity of most MOF structures is an ongoing problem,¹² therefore novel structures are highly wanted.

### SUMMARY OF THE INVENTION

Herein, we report a novel water-stable MOF with higher water uptake at low RH compared to its previous analogs.^{7,8,9} In this disclosure, we introduce a linker extension/functionalization strategy to obtain MOFs structures with boosted water uptake capacities. The extension of the linkers, wherein at least one of m or n is 1-5, provide MOFs with enhanced pores sizes and volumes. Moreover, further customization of extended linkers by changing their heterocyclic core (X, Y, Z, I) or via introduction of substituents (R1-R5) can be used to adjust or tune the water sorption properties of the respective MOFs.

The disclosed linker extension/functionalization strategy can be used increase the water uptake of the existing MOFs without significant negative effects on their longevity and hydrophilicity.

The targeted purpose of the described linker extension/functionalization strategy is to increase the water uptake of MOFs for deployment in water-harvesting devices. This application allows for usage of less material to capture the same amount of moisture at the desired RH as compared to the previously utilized MOFs.

Furthermore, the additional modifications of the extended linkers provide a variety of MOF structures with diverse water-harvesting properties. Thus, in addition to water-harvesting devices, dehumidifiers, heat pumps, adsorption refrigerators, and other appliances can benefit from usage of these novel MOF structures.

In an aspect the invention provides novel water-stable metal-organic framework (MOF) compositions with linker extension/functionalization provide higher water uptake at low relative humidity

In an aspect the invention provides a metal-organic framework (MOF) composition, comprising a metal complexed with linkers of formula:

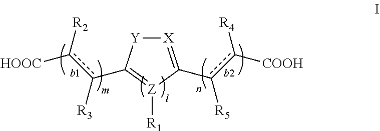

wherein
X, Y, Z are independently C(H), N(H), O or S;
R1-R5 are independently CH3, NH2, OH, halogen or H,
m is an integer 0-5;
n is an integer 1-5;
1 is an integer 1 or 2; and
b1 and b2 are independently a single or double bonds; and
at least one b2 is a double bond.

In an aspect the invention provides a metal-organic framework (MOF), comprising repeating cores, wherein the cores comprise secondary building units connected to organic ligands (linkers), wherein the secondary building units comprise one or more metals or metal-containing complexes, wherein the organic ligands (linkers) are of formula I (supra), and wherein the secondary building units are connected to the organic ligands through the oxygen atoms of the carboxylate groups in the organic ligands (linkers).

In embodiments:
R1-R5 are H; or
1, 2, 3, 4 or 5 of R1-R5 is CH3, NH2, OH or halogen.
m is 0, 1 or 2, and n is 1, 2 or 3;
m is 0, 1 or 2, and n is 1 or 2;
m is 0, and n is 1;
m is 0, and n is 2;
m is 1, and n is 1;
m is 1, and n is 2;
m is 1, and n is 3;
m is 2, and n is 2;
m is 2, and n is 3; or
m is 3, and n is 3.
1 is 1.
1, 2 or 3 of X, Y, Z are independently N(H), O or S; or
X and Y are N and NH, respectively, and Z is C.

In embodiments the MOF composition comprises linkers of formula II:

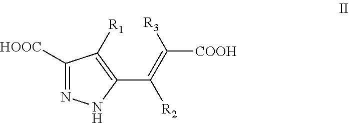

wherein
R1 is H, NH2 or OH;
R2 is H, NH2 or OH; and
R3 is H, NH2 or OH.

In an aspect the invention provides a MOF or composition herein, wherein the linkers comprise a formula of Table 1, 2, 3 or 4.

In embodiments, a MOF or composition herein, wherein the metal is a metal ion selected from Li⁺, Na⁺, K⁺, Rb⁺, Cs⁺, Be²⁺, Mg²⁺, Ca²⁺, Sr²⁺, Ba²⁺, Sc³⁺, Sc²⁺, Sc⁺, Y³⁺, Y²⁺, Y⁺, Ti⁴⁺, Ti³⁺, Ti²⁺, Zr⁴⁺, Zr³⁺, Zr²⁺, Hf⁴⁺, Hf³⁺, V⁵⁺, V⁴⁺, V³⁺, V²⁺, Nb⁵⁺, Nb⁴⁺, Nb³⁺, Nb²⁺, Ta⁵⁺, Ta⁴⁺, Ta³⁺, Ta²⁺, Cr⁶⁺, Cr⁵⁺, Cr⁴⁺, Cr³⁺, Cr²⁺, Cr⁺, Cr, Mo⁶⁺, Mo⁵⁺, Mo⁴⁺, Mo³⁺, Mo²⁺, Mo⁺, Mo, W⁶⁺, W⁵⁺, W⁴⁺, W³⁺, W²⁺, W⁺, W, Mn⁷⁺, Mn⁶⁺, Mn⁵⁺, Mn⁴⁺, Mn³⁺, Mn²⁺, Mn⁺, Re⁷⁺, Re⁶⁺, Re⁵⁺, Re⁴⁺, Re³⁺, Re²⁺, Re⁺, Re, Fe⁶⁺, Fe⁴⁺, Fe³⁺, Fe²⁺, Fe⁺, Fe, Ru⁸⁺, Ru⁷⁺, Ru⁶⁺, Ru⁴⁺, Ru³⁺, Ru²⁺, Os⁸⁺, Os⁷⁺, Os⁶⁺, Os⁵⁺, Os⁴⁺, Os³⁺, Os²⁺, Os⁺, Os, Co⁵⁺, Co⁴⁺, Co³⁺, Co²⁺, Co⁺, Rh⁶⁺, Rh⁵⁺, Rh⁴⁺, Rh³⁺, Rh²⁺, Rh⁺, Ir⁶⁺, Ir⁵⁺, Ir⁴⁺, Ir³⁺, Ir²⁺, Ir⁺, Ir, Ni³⁺, Ni²⁺, Ni⁺, Ni, Pd⁶⁺, Pd⁴⁺, Pd²⁺, Pd⁺, Pd, Pt⁶⁺, Pt⁵⁺, Pt⁴⁺, Pt³⁺, Pt²⁺, Pt⁺, Cu⁴⁺, Cu³⁺, Cu²⁺, Cu⁺, Ag³⁺, Ag²⁺, Ag⁺, Au⁵⁺, Au⁴⁺, Au³⁺, Au²⁺, Au⁺, Zn²⁺, Zn⁺, Zn, Cd²⁺, Cd⁺, Hg⁴⁺, Hg²⁺, Hg⁺, B³⁺, B²⁺, B⁺, Al³⁺, Al²⁺, Al⁺, Ga³⁺, Ga²⁺, Ga⁺, In³⁺, In²⁺, In¹⁺, Tl³⁺, Tl⁺, Si⁴⁺, Si³⁺, Si²⁺, Si⁺, Ge⁴⁺, Ge³⁺, Ge²⁺, Ge⁺, Ge, Sn⁴⁺, Sn²⁺, Pb⁴⁺, Pb²⁺, As⁵⁺, As³⁺, As²⁺, As⁺, Sb⁵⁺, Sb³⁺, Bi⁵⁺, Bi³⁺, Te⁶⁺, Te⁵⁺, Te⁴⁺, Te²⁺, La³⁺, La²⁺, Ce⁴⁺, Ce³⁺, Ce²⁺, Pr⁴⁺, Pr³⁺, Pr²⁺, Nd³⁺, Nd²⁺, Sm³⁺, Sm²⁺, Eu³⁺, Eu²⁺, Gd³⁺, Gd²⁺, Gd⁺, Tb⁴⁺, Tb³⁺, Tb²⁺, Tb⁺, Db³⁺, Db²⁺, Ho³⁺, Er³⁺, Tm⁴⁺, Tm³⁺, Tm²⁺, Yb³⁺, Yb²⁺, Lu³⁺, and combinations thereof, including any complexes which contain the metals or metal ions listed above, as well as any corresponding metal salt counter-anions.

In embodiments, the invention provides a MOF or composition herein, wherein the metal is selected from aluminum, titanium, zirconium, and hafnium.

In an aspect, the invention provides a method of making a MOF or composition herein, comprising complexing the metal with the linkers to form the MOF composition.

In an aspect, the invention provides a MOF or composition herein, comprising absorbing water in the composition.

The invention encompasses all combinations of the particular embodiments recited herein, as if each combination bad been laboriously recited.

### BRIEF DESCRIPTION OF THE DRAWINGS

FIG. 1. Organic linkers of type I (˜160° angle between the carboxylic acid groups, e.g., linkers L1-L3) generate MOFs with cis-trans-shared AlO6 rod inorganic building units (also called secondary building units, SBUs).

FIG. 2. Organic linkers of type II (˜150° angle between the carboxylic acid groups, e.g, linker L4) generate MOFs with 4cis-4trans-shared AlO6 rod inorganic building units (also called secondary building units. SBUs).

FIG. 3. Organic linkers of type III (˜120° angle between the carboxylic acid groups, e.g, linkers L5-L9) generate MOFs with cis-trans-shared AlO6 rod inorganic building units (also called secondary building units, SBUs).

FIG. 4a-g. Comparison of the framework structures and water arrangement in MOF-303 (left) and MOF-LA2-1 (right) (a) The linker 1H-pyrazole-3,5-dicarboxylic acid (H₂PZDC) of MOF-303. (b) The aluminum oxide SBUs of both MOFs consist of alternating cis-trans-corner-shared AlO₆ octahedra. (c) The linker (E)-5-(2-carboxylatovinyl)-1H-pyrazole-3-carboxylic acid (H₂PZVDC) of MOF-LA2-1, where LA2-1 refers to long-arm extension of the linker by two carbon atoms on one side. (d,e) A cut-away view of the pores displaying the alignment of the pyrazole-based linkers such that their hydrophilic N(H) functionalities point toward each other, thus generating an alternating pattern of hydrophilic and hydrophobic pockets. The framework structures and water positions were obtained by a combination of X-ray diffraction analysis and DFT optimization. The hydrophilic pockets serve as adsorption sites, which are displayed at a loading of two water molecules per respective asymmetric unit [Al(OH)(PZDC)]₂; (d) and [Al(OH)(PZVDC)]₂ (e) (f,g) Snapshots of the water structures from Monte Carlo simulations at full water loading (40 and 72 molecules per unit cell in f and g, respectively) displayed along the pore channel. Coordinate systems are given for guidance. Al, blue octahedron; C and H, gray; N. green; O in framework, pink; O in H₂O, red.

FIG. 5a-d. Experimental structural and water sorption analysis of MOF-LA2-1 in comparison to MOF-303 (a) Powder X-ray diffraction analysis using CuKα radiation Major peaks are labeled according to the associated crystallographic lattice planes. (b) Water sorption isotherms at 25° C. P, water vapor pressure; Pₛₐₜ, saturation water vapor pressure. (c) Water desorption isobars at water vapor pressures of 1.27 and 1.70 kPa. The materials were loaded at 30° C. and the respective water vapor prior to the measurement. (d) Adsorption-desorption cycling at 1.70 kPa for 150 cycles under temperature swing between 30 and 45° C.

FIG. 6a-b: Water adsorption isotherms of MOF-LA2-1 exhibiting different linker configurations. (a) Most stable ZUS and ENT linker configurations utilized for the simulation. Coordinate system is given for guidance. Al, blue octahedron, C and H, gray, N, green; O, pink. (b) Adsorption isotherms were computed using force-field-based NpT-GEMC at 298 K. The simulated and experimental data are shown as dashed and solid lines, respectively.

FIG. 7. Illustration of the four-part labeling convention serving to describe possible linker configurations in MOF-LA2-1. The μ₂-OH functionalities are labeled with Arabic numbers, indicating symmetry equivalent groups.

FIG. 8. Different linker configurations in MOF-LA2-1 optimized using DFT. The hydrophilic pocket of the MOF is shown for each configuration. MOF-LA2-1 configurations in which the pyrazole groups are present on the same side of the hydrophilic cavity (ZUS; two columns on the left) or on alternate sides of the hydrophilic cavity (ENT; two columns on the right) with trans- or cis-orientations of the vinyl group with respect to the pyrazole rings. The electronic stability per asymmetric unit [Al(OH)(PZVDC)]₂ (ΔE) of the different MOF-LA2-1 structures obtained from DFT is denoted in kJ·mol⁻¹. Coordinate system is given for guidance, Al, blue octahedron; O, pink; N, green; C and H, gray.

FIG. 9a-f. Primary water binding sites in MOF-303 (a,b), MOF-LA2-1 in the ZUS(w)-trans,trans configuration (c,d), and MOF-LA2-1 in the ENT(w)-trans,cis configuration (e,f) at water loadings of 1 (a, c, e) and 2 (b, d, f) H₂O molecules per asymmetric unit [Al(OH)(PZVDC)]₂. The average binding energy of water molecules (ΔE_{ads,avg}) is reported in kJ·mol⁻¹. The H-bond distances between the heteroatoms are given in Å. Al, blue octahedra; C and H, gray; N, green; O in framework, pink, O in H₂O, red.

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

Linker L1, an extended version of 1H-3,5-pyrazole dicarboxylic acid (linker of MOF-303), was synthesized via a two-step procedure employing a Wittig reaction followed by hydrolysis. MOF-LA2 was obtained via solvothermal synthesis between an aluminum salt, AlCl₃·6H₂O, and linker (L1) either in aq. NaOH solution or DMF/H₂O mixtures.

### Scheme for L1 Synthesis:

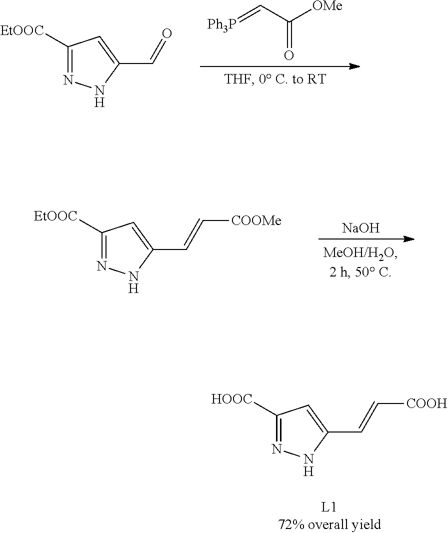

### Scheme for MOF-LA2 Synthesis:

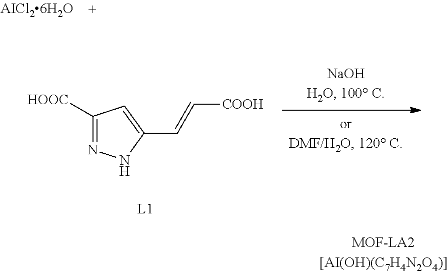 [SMILES: O=C(O)/C=C/c1cc(C(=O)O)n[nH]1]

MOF-LA2 adopts an isoreticular structure to MOF-303, as shown by its powder X-ray diffraction pattern (PXRD). The water sorption isotherm profile reveals a steep step at 26% RH with overall water uptake capacity of 0.63 g/g. This is almost 1.5 higher than that of MOF-303. Although shifted to the right in comparison with MOF-303, the water uptake step of MOF-LA2 is still in the region of RH values corresponding to the conditions at the most arid places in the world.

The cycling experiment shows negligible decrease in the total water uptake of MOF-LA2 after 29 additional cycles.

Several linker embodiments with different substituents R for the MOF-LA2 family are shown in Table 1. Introducing hydrophilic groups such as —OH and —NH₂ will shift the isotherm to even more arid RH values, while introducing hydrophobic/neutral groups such as CH₃ or halogens will move the isotherm to higher RHs. Further linker embodiments with variations of the core (X, Y, Z, l) are represented in Table 2.

TABLE 1
Examples of novel linkers for the MOF-LA2 family (R-variations).

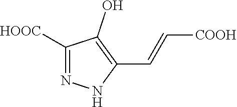 [SMILES: O=C(O)/C=C/c1[nH]nc(C(=O)O)c1O]

4-OH-L1

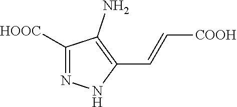 [SMILES: Nc1c(C(=O)O)n[nH]c1/C=C/C(=O)O]

4-NH₂-L1

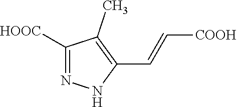

4-CH₃-L1

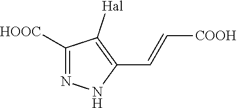

4-Hal-L1

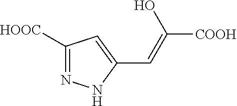 [SMILES: O=C(O)/C(O)=C/c1cc(C(=O)O)n[nH]1]

2-OH-L1

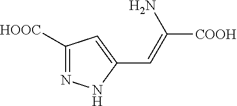 [SMILES: N/C(=C\c1cc(C(=O)O)n[nH]1)C(=O)O]

2-NH₂-L1

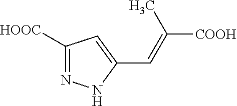

2-CH₃-L1

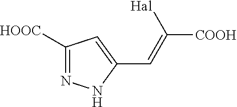

2-Hal-L1

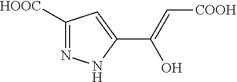 [SMILES: O=C(O)/C=C(\O)c1cc(C(=O)O)n[nH]1]

1-OH-L1

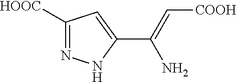 [SMILES: N/C(=C\C(=O)O)c1cc(C(=O)O)n[nH]1]

1-NH₂-L1

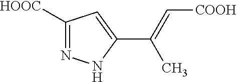

1-CH₃-L1

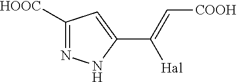

1-Hal-L1

TABLE 2
Examples of novel linkers for the MOF-LA2 family
(X, Y, Z, l-variations).

| | |
|---|---|
| 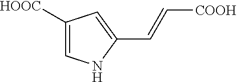 [SMILES: O=C(O)/C=C/c1cc(C(=O)O)c[nH]1] | L2 |
| 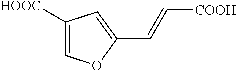 [SMILES: O=C(O)/C=C/c1cc(C(=O)O)co1] | L3 |
| 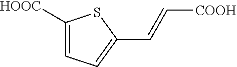 [SMILES: O=C(O)/C=C/c1ccc(C(=O)O)s1] | L4 |
| 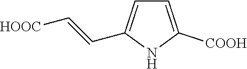 [SMILES: O=C(O)/C=C/c1ccc(C(=O)O)[nH]1] | L5 |
| 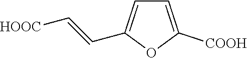 [SMILES: O=C(O)/C=C/c1ccc(C(=O)O)o1] | L6 |
| 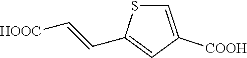 [SMILES: O=C(O)/C=C/c1cc(C(=O)O)cs1] | L7 |
| 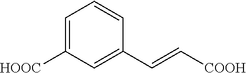 [SMILES: O=C(O)/C=C/c1cccc(C(=O)O)c1] | L8 |
| 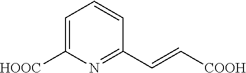 [SMILES: O=C(O)/C=C/c1cccc(C(=O)O)n1] | L9 |

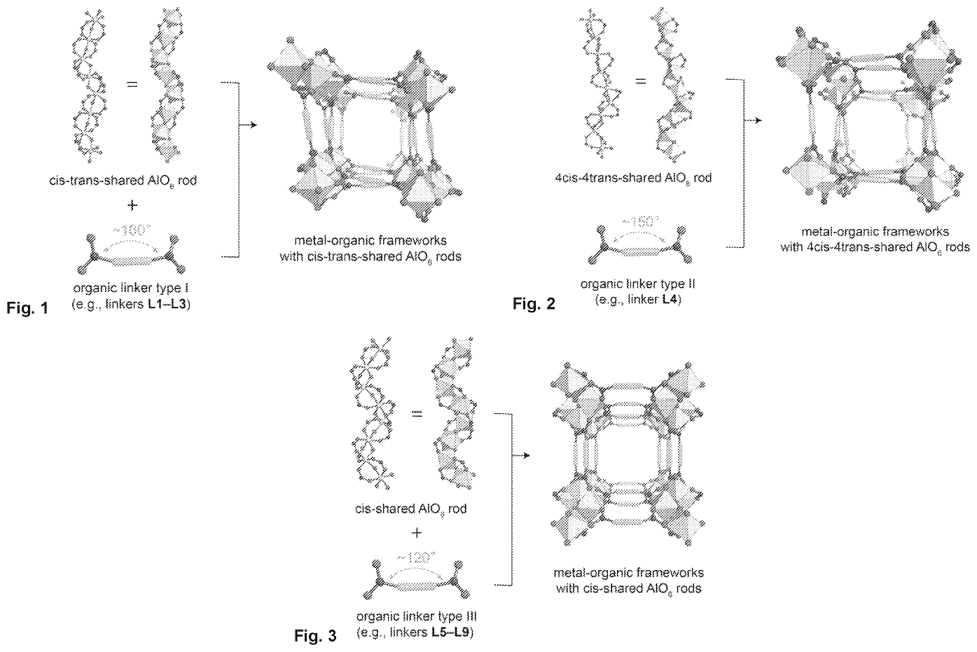

All of these can be synthesized using an identical approach as that for L1. Analogously to MOF-LA2, the tentative MOFs can be obtained via solvothermal synthesis either in aq. NaOH solution or DMA/H₂O mixtures. Linkers L1-L3 (linker type I), with a very similar angle between the carboxylic groups as L1) (˜160°), produce isoreticular MOFs to MOF-303 exhibiting cis-trans-shared AlO₆ chain inorganic building units (also called secondary building units, SBUs; FIG. 1). Linker L4 (linker type II), with an angle of ˜150°, yields a similar structure to that of CAU-23, exhibiting 4cis-4trans-shared AlO₆ chain inorganic building units (FIG. 2). Finally, linkers L5-L9 (linker type III, with ˜120°) furnish MOF structures isoreticular to the structure of CAU-10 displaying cis-shared AlO₆ chain inorganic building units (FIG. 3).

Embodiments of longer versions of L1-L9 linkers that yield the MOF-LA4 family are represented in Table 3. Representative examples of novel linkers for the MOF-LA5 family (n,m-variations) are shown in Table 4.

TABLE 3
Examples of novel linkers for the MOF-LA4 family (X, Y, Z, l-variations).

| | |
|---|---|
| 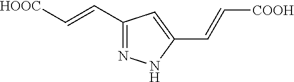 [SMILES: O=C(O)/C=C/c1cc(/C=C/C(=O)O)[nH]n1] | L10 |
| 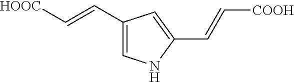 [SMILES: O=C(O)/C=C/c1c[nH]c(/C=C/C(=O)O)c1] | L11 |
| 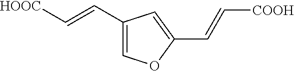 [SMILES: O=C(O)/C=C/c1coc(/C=C/C(=O)O)c1] | L12 |
| 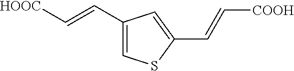 [SMILES: O=C(O)/C=C/c1csc(/C=C/C(=O)O)c1] | L13 |
| 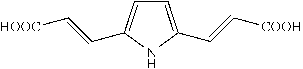 [SMILES: O=C(O)/C=C/c1ccc(/C=C/C(=O)O)[nH]1] | L14 |
| 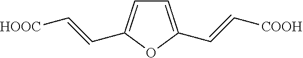 [SMILES: O=C(O)/C=C/c1ccc(/C=C/C(=O)O)o1] | L15 |
| 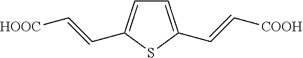 [SMILES: O=C(O)/C=C/c1ccc(/C=C/C(=O)O)s1] | L16 |
| 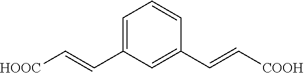 [SMILES: O=C(O)/C=C/c1cccc(/C=C/C(=O)O)c1] | L17 |
| 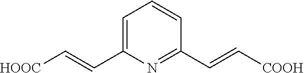 [SMILES: O=C(O)/C=C/c1cccc(/C=C/C(=O)O)n1] | L18 |

TABLE 4
Examples of novel linkers for the MOF-LA5 family (n,m-variations).

| | |
|---|---|
| 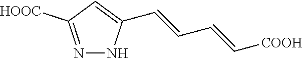 [SMILES: O=C(O)/C=C/C=C/c1cc(C(=O)O)n[nH]1] | L19 |
| 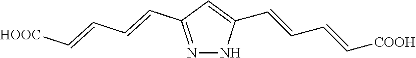 [SMILES: O=C(O)/C=C/C=C/c1cc(/C=C/C=C/C(=O)O)[nH]n1] | L20 |

A representative method for synthesis of the linkers L10-L18, shown for L15, relies on a Knovenagel condensation of the corresponding bis-aldehyde with malonic acid¹³.

### Scheme for L15 Synthesis.

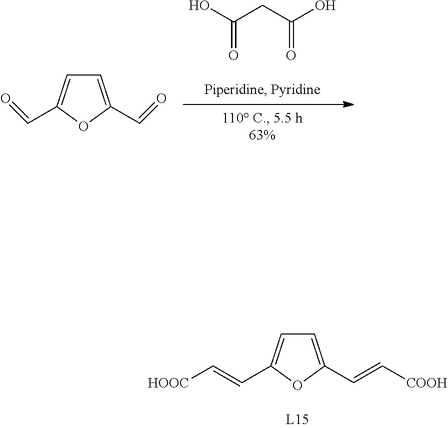 [SMILES: O=C(O)CC(=O)O ; O=Cc1ccc(C=O)o1 ; O=C(O)/C=C/c1ccc(/C=C/C(=O)O)o1]

### REFERENCES

1. Mekonnen, M. M.; Hoekstra, A. Y. Four Billion People Facing Severe Water Scarcity. Sci. Adv. 2016, 2, e1500323-e1500323.
2. Gleick, P. H. Water in Crisis: A Guide to the World's Fresh Water Resources, Oxford Univ Press, 1993.
3. Fathieh, F.; Kalmutzki, M. J.; Kapustin, E. A.; Waller, P. J.; Yang, J.; Yaghi, O. M. Practical Water Production from Desert Air. Sci. Adv. 2018, 4. eaat3198.
4. Hanikel, N.; Prévot, M. S.; Yaghi, O. M. MOF Water Harvesters. Nat. Nanotechnol. 2020, 15, 348-355.
5. Kalmutzki, M. J.; Diercks, C. S.; Yaghi, O. M. Metal-Organic Frameworks for Water Harvesting from Air. Adv. Mater. 2018, 30, 1704304.
6. Byun, Y.; Je, S. H.; Talapaneni, S. N.; Coskun, A. Advances in Porous Organic Polymers for Efficient Water Capture. Chem. Eur. J. 2019, 25, 10262-10283.
7. Hanikel, N.; Prévot, M. S.; Fathieh, F.; Kapustin, E. A.; Lyu, H.; Wang, H.; Diercks, N. J.; Glover, T. G.; Yaghi, O. M. Rapid Cycling and Exceptional Yield in a Metal-Organic Framework Water Harvester ACS Cent. Sci., 2019. 5, 1699-1706.
8. Hanikel, N.; Pei, X.; Chheda, S.; Lyu, H.; Jeong, W.; Sauer, J.; Gagliardi, L.; Yaghi, O. M. Evolution of Water Structures in Metal-Organic Frameworks for Improved Atmospheric Water Harvesting. Science, 2021, 374, 454-459.
9. Cadiau, A., et al. Design of Hydrophilic Metal Organic Framework Water Adsorbents for Heat Reallocation. Adv. Mater., 2015, 27, 4775-4780.
10. Wahlgren, R. V. Atmospheric Water Vapour Processor Designs for Potable Water Production. A Review. Water Res. 2001, 35, 122.
11. Xu, W., Yaghi, O. M. Metal-Organic Frameworks for Water Harvesting from Air, Anywhere, Anytime. ACS Cent. Sci., 2020, 6, 1348-1354.
12. Burtch, N. C.; Jasuja, H.; Walton, K. S. Water Stability and Adsorption in Metal-Organic Frameworks. Chem. Rev. 2014, 114. 10575-10612 .
13. Sibi, Mukund P. et al. Preparation of Novel Monomers from Biomass, PCT Int. Appl. 2016. 2016022943.

### Example. MOF Linker Extension Strategy for Enhanced Atmospheric Water Harvesting

ABSTRACT: A linker extension strategy for generating metal-organic frameworks (MOFs) with a superior moisture-capturing properties is presented. Applying a cooperative design approach that combines experiment and computation results in MOF-LA2-1 {[Al(OH)(PZVDC)], where PZVDC²⁻ is (E)-5-(2-carboxylatovinyl)-1H-pyrazole-3-carboxylate} exhibiting a 50% water capacity increase compared to the state-of-the-art water-harvesting material MOF-303. The power of this approach is the increase in pore volume without compromising the ability of the MOF to harvesting water in and environments under long-term uptake and release cycling, as well as affording a reduction in regeneration heat and temperature. Density functional theory calculations and Monte Carlo simulations give detailed insight pertaining to framework structure, water interactions within its pores, and the resulting water sorption isotherm.

### INTRODUCTION

Water stress already affects about half of the world population.^{1,2} Given that there is clean water in the atmosphere, porous and hygroscopic sorbents are being investigated for water extraction from air.^{3,4} An ideal water-harvesting material should (i) take up water at a desirable relative humidity (RH), including from desert air, (ii) exhibit step-shaped moisture uptake behavior to allow for uptake and release of large amounts of water by minor perturbations in temperature or pressure, (iii) display facile water release to reduce the energy consumption and increase the productivity. (iv) have hydrothermal stability to enable long-term operation, and (v) be made from non-toxic, abundant components using environmentally benign processes.

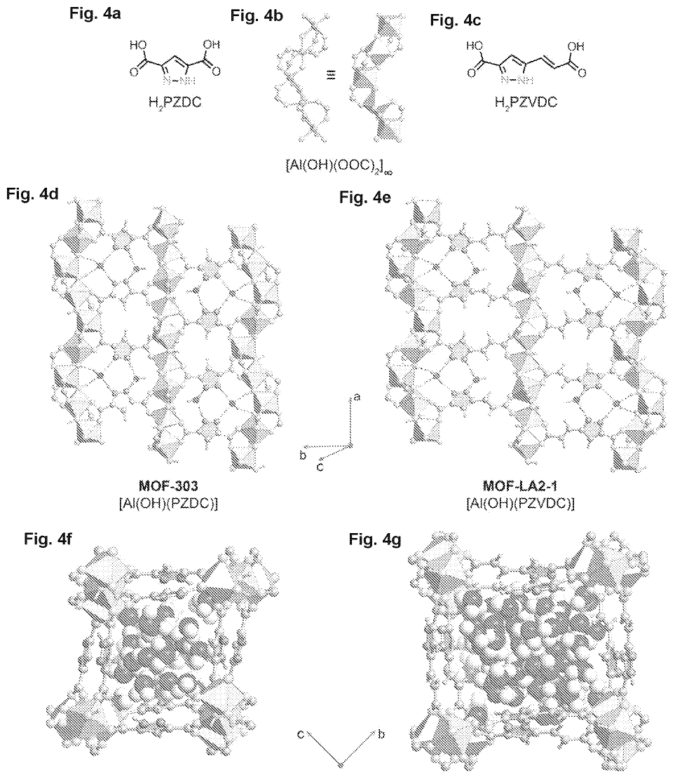

In this regard, metal-organic frameworks (MOFs) are promising materials because of the facility with which they can be designed and modified to achieve a desired property,⁵⁻⁷ which has led to their successful implementation for atmospheric water harvesting.⁸⁻¹⁴ In particular, the discovery of MOF-303 {[Al(OH)(PZDC)], where PZDC²⁻ is 1H-pyrazole-3,5-dicarboxylate; FIG. 4a} represents an important advance toward meeting the above-described sorbent requirements.¹¹ Specifically, the aluminum oxide rodlike secondary building units (SBUs; FIG. 4b) impart hydrothermal stability to the framework, and, jointly with the aligned PZDC²⁻ linkers, generate pores lined by alternating hydrophilic-hydrophobic pockets. Single-crystal X-ray diffraction revealed how these pockets are ideally suited for binding of initial water molecules that seed the evolution of the overall water structure.¹⁵

The conundrum solved by the present study is how to retain the alternating hydrophilic-hydrophobic pocket environment while simultaneously increasing the water uptake capacity of the framework. In other words, how to increase the pore volume of MOF-303 without compromising its favorable water-uptake attributes. The usual strategy to increase the pore volume of aluminum MOFs made from rodlike SBUs is linker extension, involving either polycyclic aromatic linkers or appending additional aromatic rings to the linker.¹⁶⁻¹⁹ However, these approaches generated either hydrophobic, less porous, or large-pore hydrolytically labile aluminum frameworks.^{16,19,22}

Herein, through an integrated experimental computational approach we identified and implemented a suitable linker extension strategy involving appending a single vinyl group to PZDC²⁻ (FIG. 4a). The corresponding MOF, termed MOF-LA2-1 {[Al(OH)(PZVDC)], where PZVDC²⁻ is (E)-5-(2-carboxylatovinyl)-1H-pyrazole-3-carboxylate; FIG. 4c}, is isostructural to MOF-303 but with a 50% increase in pore volume and hence water uptake. Although MOF-LA2-1 exhibits a slightly shifted step to higher RH in its isotherm compared to MOF-303, it is still suitable for arid environments. Additionally, this MOF offers a significantly reduced regeneration temperature and enthalpy, as well as high stability upon water adsorption-desorption cycling.

### RESULTS AND DISCUSSION

At the outset of this study, we hypothesized that addition of a relatively compact, yet long group to the hydrophilic H₂PZDC linker utilized in MOF-303 will enhance its water uptake capacity while leveraging its hydrophilic nature and its excellent stability (FIG. 4c) In particular, we were keen to retain the arrangement of pyrazole functionalities, which served as primary adsorption sites and were key for its favorable water-harvesting properties (FIG. 4d).¹⁵ Density functional theory (DFT) calculations to find periodic structures consistent with the MOF-303 topology indicated that a vinyl-appended variant would offer a favorable increase in the pore volume (Section S3.1). Accordingly, the linker H₂PZVDC featuring a vinyl group extension of H₂PZDC was synthesized via a two-step procedure employing a Wittig reaction on ethyl 5-formyl-1H-pyrazole-3-carboxylate followed by hydrolysis (Section S2). MOF-LA2-1 was then obtained using AlCH₃·6H₂O and H₂PZVDC by solvothermal synthesis in a DMF/H₂O (1:4) mixture at 120°° C. and also by a green synthesis procedure in H₂O under reflux and stirring (Section S2)

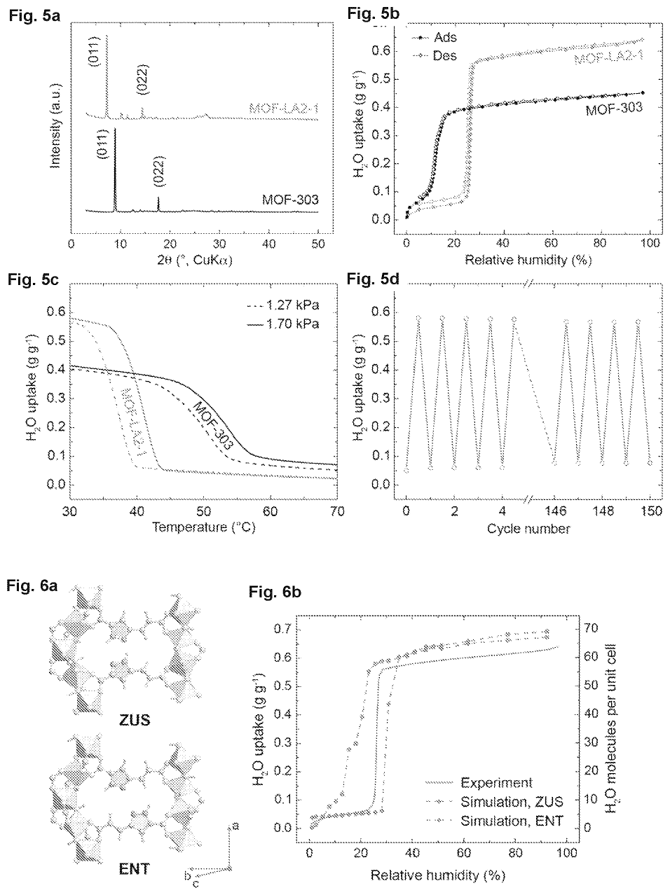

The resulting microcrystalline powder was first characterized by powder X-ray diffraction (PXRD) analysis. A significant 2θ shift of the corresponding PXRD reflections to lower values compared to MOF-303 was indicative of successful isoreticular extension of the parent framework (FIG. 5a). Additionally, these data together with scanning electron microscopy coupled with energy dispersive X-ray spectroscopy confirmed phase purity of the prepared sample (Sections S4). Furthermore, we undertook significant efforts to obtain single crystals suitable for single-crystal X-ray diffraction (SCXRD) analysis of MOF-LA2-1, which resulted in crystals of 10×10×30 μm³. While synchrotron SCXRD data gave us insight regarding the unit cell parameters (a=12.030(12) Å, b=17.398(17) Å, c=17.706(17) Å, and β=99.33(2)°) and the SBU stereochemistry, we hypothesize that due to the substantial intrinsic positional disorder of the asymmetric linker in the crystal structure, the crystallinity of these crystals was relatively low, thus limiting the overall SCXRD data quality and preventing us from obtaining the exact linker configuration in MOF-LA2-1.

Thus, we utilized periodic DFT optimizations to probe the relative stability of the different possible linker configurations in the MOF-LA2-1 structure at the unit cell parameters extracted from SCXRD data (Section S3.2). In this context, a total of 16 possible backbone configurations of the framework featuring different positions and orientations of the pyrazole and vinyl groups in the hydrophilic cavity of the MOF were considered. Generally, the configurations where the pyrazole functionalities were on the same side of the pocket (ZUS, from German ‘zusammen’, together; as in FIG. 4e) were estimated to be more stable than configurations with the pyrazole moieties on opposite sides of the pocket (ENT, from German ‘entgegen’, opposite). We hypothesize that the pyrazole functionalities in the ZUS configuration of MOF-LA2-1 can hydrogen bond to each other, thus stabilizing the associated structural arrangement. This is further supported by the fact that the pyrazole moieties lie in the same plane in this configuration, whereas they do not lie in a common plane in the ENT configuration. Overall, one ZUS structure (FIG. 4e) was identified as particularly stable with the next most stable configurations lying 27 KJ mol⁻¹ {per asymmetric unit [Al(OH)(PZVDC)]₂} higher in energy (Section S3.2), thus being the most represented configuration of MOF-LA2-1.

As discussed earlier, MOF-LA2-1 was derived from MOF-303 by adding a vinyl group to the H₂PZDC linker molecule with the goal of enhancing its water uptake capacity while retaining the arrangement of the pyrazole functionalities, which were determined to be key to the water-harvesting properties of MOF-303. Having determined the most stable framework configuration, we investigated the primary water adsorption sites of MOF-LA2-1 in this arrangement computationally and compared them with the respective sites in MOF-303 (FIG. 4d,e). Indeed, similar to the primary water adsorption sites in MOF-303, water molecules were adsorbed in sites constituted by the linker pyrazole groups as well as μ₂-OH groups of the aluminum SBU. The first water molecule adsorbed through four hydrogen bonds (2.7-3.0 Å) with the framework—one each with the N and NH groups of the linker, and two with the μ₂-OH groups of the aluminum SBU. The second water molecule adsorbed through two hydrogen bonds (both at 2.7 Å), each with the remaining N and NH groups (FIG. 4e). These water adsorption sites were very similar to those observed in MOF-303 (FIG. 4d). where the first water molecule adsorbed with comparable strength in MOF-303. The second water molecule adsorbed weakly relative to MOF-303 (Section S3.3), which contributes to the shift in the isotherm towards slightly higher RH compared to MOF-303 (see below). The subsequent water molecule is anticipated to adsorb on the remaining μ₂-OH group of the aluminum SBU and additional water molecules to fill the pore by forming a hydrogen-bonded network, as observed previously in MOF-303 (FIG. 4f,g).¹⁵

Considering the insights gained through DFT calculations, we refined the structural model of MOF-LA2-1 in its most stable configuration (FIG. 4e) against the experimental PXRD data. The framework was modeled in the P2₁/c space group (No. 14) and the final unit cell parameters refined to a=12.1 Å, b=17.4 Å, c=17.8 Å, and β=98.6°, with good agreement with the SCXRD data.

Next, the thermal stability and porosity of MOF-LA2-1 were studied using thermogravimetric analysis (TGA) and nitrogen sorption analysis, respectively. TGA under both argon and air atmosphere revealed no significant weight loss below 300° C. This indicated excellent stability required for thermal regeneration during the water-harvesting operation. Initial evaluation of the nitrogen sorption isotherm at 77 K of MOF-LA2-1 revealed a Brunauer-Emmett-Teller (BET) surface area and a pore volume of 1892 m² g⁻¹ and 0.67 cm³ g⁻¹, respectively—values 1.4 times higher compared to MOF-303.¹⁵

The water-harvesting properties of MOF-LA2-1 were first probed by performing water sorption measurements under isothermal conditions. Similar to the parent framework, the extended framework displayed a pre-step in its isotherm, which is very likely associated with the presence of a hydrophilic pocket formed by the pyrazole functionalities, thus forming strong water adsorption sites, as was previously observed for MOF-303.¹⁵ Notably, the water sorption isotherm profile exhibited a steep step at 26% RH with a total water uptake of 0.64 g g⁻¹—a 50% higher water capacity than MOF-303 (FIG. 5b). Although shifted to slightly higher RH values in comparison with MOF-303, the step position of MOF-LA2-1 is still suitable for water harvesting in the most arid regions of the world.^{23,24} In addition, we conducted water sorption analysis at different temperatures and utilized these data to assess the isosteric heat of water adsorption Qₛₜ using the Clausius-Clapeyron relation. We found that MOF-LA2-1 exhibited an average Qₛₜ value of 50 kJ mol⁻¹—an overall reduction of 4 kJ mol⁻¹ compared to its parent framework evaluated at similar conditions.²⁵ Considering the heat of condensation of water (44 kJ mol⁻¹ at 25° C.), this resembles a 40% lower heat of adsorption penalty compared to MOF-303. Importantly, we note that the favorable water sorption properties of MOF-LA2-1 were not compromised when using the green reflux-based synthesis for its preparation.

Furthermore, the regeneration temperature of MOF-LA2-1 was probed by measuring isobaric desorption curves. These measurements were conducted at water vapor pressures of 1.27 and 1.70 kPa (corresponding to 30 and 40% RH at 30° C., respectively) and demonstrated substantially reduced water release temperatures compared to MOF-303 (FIG. 5c), thus allowing for a very desirable operational desorption temperature of 45° C. Together with the significantly reduced isosteric heat of adsorption, these findings substantiate MOF-LA2-1 as an energy efficient water-harvesting material for arid regions.

To examine the stability of MOF-LA2-1 at the operational conditions, temperature swing adsorption-desorption cycling was performed at 1.70 kPa water vapor pressure (FIG. 5d). This experiment showed a 5% decrease in water uptake working capacity after 75 cycles and a further 1% decrease after 75 additional cycles, thus indicating a leveling off in the capacity loss and an overall good longevity of MOF-LA2-1.

We next studied the dependence of the water adsorption behavior on the different linker configurations of MOF-LA2-1. For that, force-field-based Monte Carlo simulations in the Gibbs ensemble were used to compute the water adsorption isotherms at 298 K (Section S3.4). We focused these efforts on the most stable ZUS and ENT configurations, which served as representative examples of the different structural ensembles (Section S3.4). The simulated water sorption isotherms of the two structural types displayed significantly different profiles (FIG. 6a-b): In good agreement with the measured adsorption isotherm, the ZUS configuration showed an initial water uptake of approximately five water molecules per unit cell consisting of four asymmetric units at 5% RH and a sharp isotherm step at 30% RH. In contrast, the computed isotherm of MOF-LA2-1 in the ENT configuration exhibited a more gradual profile, which could be explained by a greater number of water adsorption sites of varying binding strength with the pore walls. Based on comparison with the experimental water sorption isotherm, it can be concluded that the isotherm of the ZUS configuration is more representative of the experimental data, thus further supporting our structural model (FIG. 4e).

In conclusion, we have demonstrated a linker ‘arm’ extension strategy and employed it to significantly enhance the water-harvesting properties of the state-of-the-art water-harvesting material MOF-303. Importantly, this features a 50% increase of the water uptake capacity as well as reduced operational energetic requirements, while retaining the ability for moisture capture in arid regions and the hydrothermal stability suitable for long-term uptake and release cycling. This approach is generalizable and is particularly useful for commercially relevant aluminum-based MOFs.

### Section S2. Synthetic Procedures

Synthesis of (E)-5-(2-carboxyvinyl)-1H-pyrazole-3-carboxylic acid (H₂PZVDC):

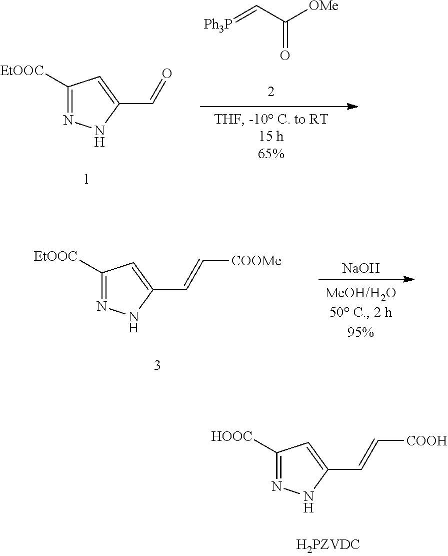

Step 1:¹³ A 100-mL round-bottom flask equipped with a stirring bar was charged with 1 (1.5 g, 8.9 mmol. 1 equiv.) and dry THF (50 mL) under argon atmosphere. The mixture was cooled down to −10° C. using acetone/ice bath, and 2 (3.5 g, 10.5 mmol, 1.2 equiv.) was added portion-wise. The reaction was allowed to warm up to room temperature overnight. After concentrating the resulting solution under reduced pressure, a mixture containing E and Z-isomers was identified via ¹H NMR analysis. The desired E-isomer 3 was isolated via column chromatography using acetone/hexane (5/1) as eluent (R_{f}=0.1). Yield: 1.3 g, 65%

¹H NMR (400 MHz, CDCl₃) δ 10.93 (s, 1H), 7.67 (d, J=16.0 Hz, 1H), 7.04 (s, 1H), 6.48 (d, J=16.0 Hz, 1H), 4.41 (q, J=7.1 Hz, 2H), 3.81 (s, 3H), 1.41 (t, J=7.1 Hz, 3H) ppm.

Step 2: A 100-mL round-bottom flask equipped with a stirring bar was charged with 3 (1.3 g, 5.8 mmol, 1 equiv.), MeOH (50 mL) and aqueous NaOH solution (20 mL, 1.5 M, 5 equiv.). The reaction was heated at 50° C. (oil bath temperature) until the starting material was consumed, as monitored by TLC (2 h). The solution was concentrated under reduced pressure and 5 M HCl was added dropwise until pH=2-3. The resulting precipitate was filtered off and thoroughly washed with H₂O (4×10 mL) and MeOH (1×5 mL) After drying at 50° C. in vacuo, the linker H₂PZVDC was obtained as white powder. Yield: 1.0 g, 95%. ¹ H NMR (500 MHz, DMSO-d₆) δ 13.80-13.10 (br. s, 3H), 7.46 (d, J=16.2 Hz, 1H), 7.17 (s, 1H), 6.53 (d, J=16.1 Hz, 1H). ¹³C NMR (126 MHz, DMSO-d₆) ppm. δ 167.4, 161.4, 120.6, 108.4 ppm. HRMS (m/z). [M−H]⁻ calcd. for C₇H₅N₂O₄, 181.0255; found, 181.0255.

### Solvothermal Synthesis of MOF-LA2-1:

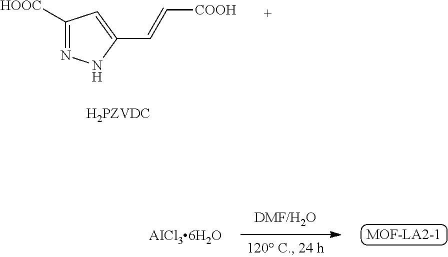 [SMILES: O=C(O)/C=C/c1cc(C(=O)O)n[nH]1]

In a 4-mL scintillation vial, linker H₂PZVDC (91.0 mg, 0.5 mmol, 1 equiv.) was dissolved in N,N-dimethylformamide (DMF) (0.6 mL) upon sonication. An aqueous solution of AlCl₃ 6H₂O) (2.4 mL, 0.2 M, 1 equiv.) was added dropwise, and the resulting mixture was heated in a 120°° C. oven for 24 h. After cooling down to room temperature, the white precipitate was collected by centrifuging and washed with H₂O (3×30 mL) and MeOH (3×30 mL). MOF-LA2-1 was activated under dynamic vacuum (˜10⁻³ mbar) for 12 h at room temperature, followed by gradual heating to 120°° C. for 6.5 hours. Yield. 65.0 mg. 58%. Elem. Anal. of MOF-LA2-1. Calcd. for C₅₆H₄₀N₁₆O₄₀Al₈. C, 37.52; H, 2.25, N, 12.50%. Found: C, 36.78; H, 2.38, N, 11.95%.

### Green Synthesis of MOF-LA2-1:

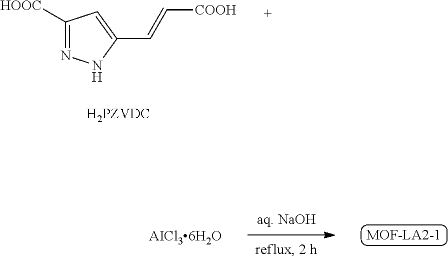 [SMILES: O=C(O)/C=C/c1cc(C(=O)O)n[nH]1]

In a 50-mL round-bottom flask, linker H₂PZVDC (364 mg, 2 mmol, 1 equiv.) and NaOH (160 mg, 4 mmol, 2 equiv) were dissolved in deionized water (10 mL) upon sonication. An aqueous solution of AlCl₃·6H₂O (6 mL, 0.33 M, 1 equiv.) was added dropwise for 10 minutes, and the reaction mixture was heated to 120°° C. and refluxed for 2 hours. After cooling down to room temperature, the white powder was collected by centrifuging and washed with deionized water (2×10 mL) and EtOH (3×10 mL). The white powder was dried under air overnight, followed by activation under dynamic vacuum (˜10⁻³ mbar) for 12 hours at 120° C. Yield: 301 mg. 66%. Elem. Anal. of MOF-LA2-1: Calcd. for C₅₆H₄₀N₁₆O₄₀Al₈: C, 37.52; H, 2.25; N, 12.50%. Found: C. 37.29, H, 2.43; N. 12.10%.

### Section S3. Computational Study of MOF-LA2-1

### Section S3.1. Initial Prediction of the Pore Volume and Water Adsorption Properties

We first constructed a hypothetical MOF, MOF-LA2-1, from the parent MOF-303 wherein the PZDC²⁻ (1H-pyrazole-3,5-dicarboxylate) linkers of MOF-303 were replaced with PZVDC²⁻ linkers containing an extension by a vinyl group. Without any a priori knowledge of the experimental crystal structure of this MOF, we constructed a DFT-optimized structure of this MOF, where the contact angle between the aluminum oxide rods and linkers was similar to that in MOF-303 with the pyrazole groups forming an alternating pattern of hydrophilic-hydrophobic pockets. In this arrangement, the vinyl group extension allowed for a more than 30% increase in pore volume compared to the parent MOF (0.598 cm³ g⁻¹ versus 0.452 cm³ g⁻¹). Force-field-based Monte Carlo simulations in the NpT-Gibbs ensemble (see Section S1, Computational Methods for more details) were used to predict the water adsorption isotherm of MOF-LA2-1 at 298 K. The simulated adsorption isotherm showed a steep step at a relative humidity of ˜18% and an overall water uptake of 0.6 g g⁻¹—a 1.5-fold increase compared to the MOF-303 uptake predicted using the same procedure.

### Section S3.2. Stability of Different Linker Configurations in MOF-LA2-1

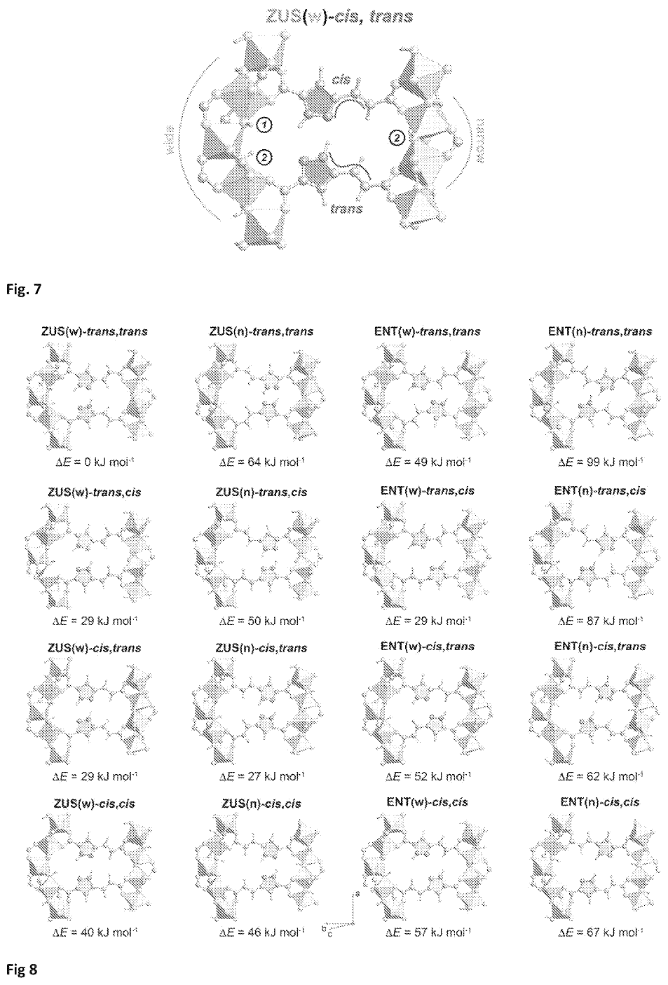

We utilized DFT calculations to probe the relative stability of the different possible linker configurations in the MOF-LA2-1 structure. A total of sixteen different linker configurations (FIG. 8), varying in the position and orientation of the pyrazole and vinyl groups in the hydrophilic cavity of the MOF were considered. We use a four-part labeling convention for these different linker configurations, which are depicted for classification purposes such that the wide side of the pocket is on the left and the symmetry equivalent μ₂-OH groups (labeled as 2; FIG. 7) are on the bottom left and right side of the pocket. The first part of the naming convention indicates whether the pyrazole groups from the opposite linkers in the hydrophilic pocket of the MOF are on the side {denoted as ZUS (from German ‘zusammen’, together)} or on alternate sides {denoted as ENT (from German ‘entgegen’, opposite)} of the cavity. The second part of the naming convention indicates if the pyrazole ring at the top of the cut-away view is located on the wide (denoted as w) or narrow (denoted as n) side of the pocket Lastly, the geometries of the vinyl groups with respect to the corresponding pyrazole rings are reflected via the cis trans notation starting with the linker on the top.

The relative stabilities of the different linker configurations were evaluated using periodic DFT optimizations (PBE-D3/850 eV level of theory, see Section S1, Computational Methods for more details) of the framework atoms of the empty MOF constrained to the lattice parameters determined experimentally (see Section S6 for more details). In general, the ZUS linker configurations, in which the pyrazole groups are opposite to each other in the hydrophilic cavity of the MOF, were found to be more stable compared to the ENT linker configurations, which could be attributed to potential hydrogen-bond stabilization between the opposing pyrazole groups in the ZUS linker configurations. Moreover, the ZUS linker configurations in which the pyrazole groups were present on the wider side of the hydrophilic cavity {ZUS(w)} were found to be more stable compared to the linker configurations in which the pyrazole groups were present on the narrower side of the hydrophilic pocket {ZUS(n)}. This could be explained by potential steric constraints associated with both relatively large pyrazole moieties being present on the narrow side of the pocket. In contrast to the ZUS linker configurations, in which the pyrazole groups in the hydrophilic MOF cavity were aligned in the same plane, the pyrazole groups in the hydrophilic cavity of the MOF with ENT linker configurations were not aligned in a common plane. The orientation of the vinyl group was also found to influence the relative stability of the MOF-LA2-1 structures. Generally, the presence of cis-oriented vinyl groups relative to the pyrazoles in the ZUS(w) configurations destabilized the MOF structures In contrast, the ZUS(n) configurations were stabilized by presence of cis-oriented vinyl groups.

To summarize, the ZUS(w)-trans,trans linker arrangement was found to be the most stable configuration of MOF-LA2-1. Four other linker configurations (namely ZUS(n)-cis,trans; ENT(w)-trans,cis; ZUS(w)-trans,cis; and ZUS(w)-cis,trans) were identified as energetically reachable linker configurations {with ΔE values of 27-29 kJ mol⁻¹ per asymmetric unit [Al(OH)(PZVDC)]₂, that is ˜4 k_{B}T at MOF synthesis temperatures of 373-393 K}. The first four structures were used as representative structures to investigate the water adsorption behavior in MOF-LA2-1; calculations were not carried out for ZUS(w)-cis,trans due to its similarity to ZUS(w)-trans,cis.

### Section S3.3 Determination of the Primary Water Adsorption Sites

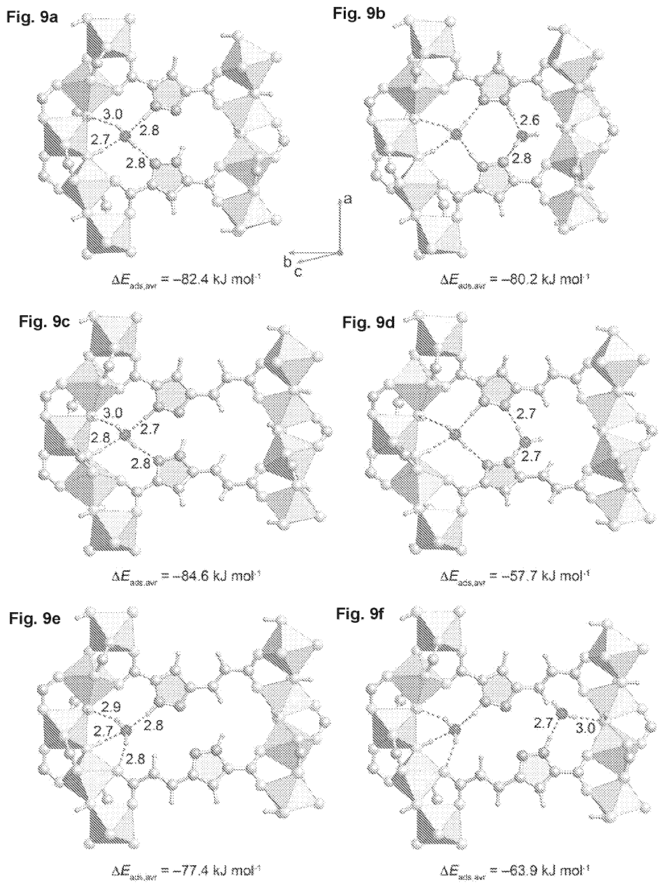

MOF-LA2-1 was derived from MOF-303 by adding a compact, yet long vinyl group to the PZDC²⁻ linker of MOF-303 with the goal of enhancing the water uptake capacity of MOF-303 while retaining its arrangement of the pyrazole functionalities, which was determined to be key for the favorable water-harvesting properties of MOF-303. To demonstrate this, we investigated the primary water adsorption sites in the ZUS(w)-trans,trans and ENT(w)-trans,cis linker configurations of MOF-LA2-1, which served as representative structures for the ZUS and ENT configurations. Indeed, similar to the primary water adsorption sites determined previously in MOF-303 (FIG. 9a,b), water molecules are adsorbed in sites constituted by pyrazole moieties as well as μ₂-OH groups of the aluminum oxide rods in both linker configurations.

In the ZUS(w)-trans,trans linker configuration, the first water molecule forms four H bonds (2.7-3.0 Å) with the framework—one each with the NH and N groups of the two neighboring linkers, and two with the μ₂-OH groups of the aluminum oxide rod (ΔE_{ads,avg}=−84.6 kJ mol⁻¹, FIG. 9c). The second water molecule adsorbs through two H bonds (2.6 and 2.8 Å)—one each with the NH and N groups of the remaining, neighboring pyrazole moieties (ΔE_{ads,avg}=−57.7 kJ mol⁻¹; FIG. 9d). These water adsorption sites are similar to those observed in MOF-303, where the first H₂O molecule adsorbs with a comparable strength and the second H₂O molecule adsorbs stronger than in MOF-LA2-1 {ΔE_{ads,avg}=−82.4 and −80.2 kJ mol⁻¹ at 1 and 2 H₂O molecules per asymmetric unit [Al(OH)(PZDC)]₂, respectively; FIG. 9a,b}. Subsequent water molecules are anticipated to adsorb at the remaining μ₂-OH groups of the Al oxide rod, as observed previously for MOF-303.¹

In contrast, the H₂O adsorption sites differ in the ENT(I)-trans,cis linker configuration, which could be explained by the spatial separation of the pyrazole groups. The first H₂O molecule adsorbs through four H bonds with the framework (2.7-2.9 Å)—one with the NH group, two with the μ₂-OH groups, and one with the carboxylate group of the linker (ΔE_{ads,avr}=−77.4 kJ mol⁻¹; FIG. 9e). The second H₂O molecule adsorbs through two H bonds (2.7 and 3.0 Å)—one with the NH group and one with the μ₂-OH group of the Al oxide rod (ΔE_{ads,avg}=−63.9 kJ mol⁻¹; FIG. 9f). We note that in this linker configuration, the N groups of the linkers can adsorb subsequent water molecules. thereby leading to a higher number of favorable sites for H₂O adsorption compared to MOF-303.

### Section S3.4 Simulation of Water Adsorption Isotherms

We next probed the dependence of the water adsorption behavior on the different linker configurations of MOF-LA2-1. Force-field-based Monte Carlo (MC) simulations in the isobaric-isothermal (NpT) Gibbs ensemble were used to compute the water adsorption isotherms at 298 K. Considering the similarity of the primary adsorption sites in MOF-LA2-1 and MOF-303 (Section S3.3), the simulation setup was chosen to be similar to a previous study focusing on the prediction of water adsorption isotherms of MOF-303 (see Section S1, Computational Methods for more details).² Rigid framework structures of MOF-LA2-1, optimized in the presence of 4 H₂O molecules per unit cell (corresponding to 1 H₂O per asymmetric unit) that were deleted prior to the MC simulations, were used for these calculations. This arrangement led to an expanded hydrophilic cavity, thus accounting for the structural flexibility of the MOF, which was previously shown to be important for obtaining the appropriate initial water uptake in MOF-303.²

Using the above-described procedure, the water adsorption isotherms of MOF-LA2-1 in the ZUS(w)-trans,trans; ZUS(n)-cis,trans; ZUS(w)-trans,cis; and ENT(w)-trans,cis linker configurations were simulated. Noteworthy, the ZUS and ENT linker configurations exhibit significantly different water adsorption behavior. In agreement with the measured adsorption isotherm, both the ZUS(w)-trans,trans and ZUS(w)-trans,cis configurations, in which the pyrazole groups are present on the wider side of the hydrophilic cavity, show an initial water uptake of ˜5 water molecules per unit cell already at a relative humidity (RH) of 5% and a sharp step in the isotherm step at ˜30% RH, slightly shifted compared to the experimental isotherm. We note that these two linker configurations differ only in the orientation of the vinyl groups, and the similar adsorption behavior of these two linker configurations suggests that the orientation of the vinyl groups (cis or trans) does not significantly influence the overall adsorption isotherm. On the other hand, the ZUS(n)-cis,trans linker configuration, in which the pyrazole groups are present on the narrowed side of the hydrophilic cavity, does not exhibit the initial water uptake at <10% RH observed in the experimental isotherm, even though the framework structure used for this linker configuration was optimized in the presence of 4 H₂O molecules per unit cell. This is consistent with the observation that the water molecules did not adsorb at the ‘strong’ adsorption sites during the DFT optimization, as observed for the other ZUS linker configurations. Instead, the adsorbed water molecules move out of the plane of the two pyrazole linkers into the MOF pore, thereby not expanding the cavity significantly upon water adsorption. This linker configuration displayed a steep step in the isotherm at ˜22% RH, thus exhibiting a larger deviation from the experimental isotherm than the ZUS(w) configurations

In contrast to the steep step observed in the adsorption isotherms for the three investigated ZUS linker configurations, the ENT(w)-trans,cis linker configuration exhibited a more gradual increase in its water uptake. The pyrazole functionalities are more distributed across the hydrophilic cavity, leading to a greater number of energetically favorable adsorption sites in the framework compared to the ZUS linker configurations. Considering the steep profile of the experimental isotherm, we conclude that the ENT linker configuration is not a suitable structural model, while the ZUS(w)-trans,trans and ZUS(w)-trans,cis linker configurations appear to be good representatives of the synthesized MOF-LA2-1.

TABLE S1
Fractional atomic coordinates of MOF-LA2-1 in the ZUS(w)-
trans,trans configuration {monoclinic, P2₁/c (No.
14), a = 12.1 Å, b = 17.3 Å, c =
17.8 Å, β = 98.6°}, obtained through
Pawley refinement of the respective structural model
against the experimental PXRD data.

| Atom | x | y | z |
|---|---|---|---|
| Al1 | 0.76311 | 0.44853 | 0.56349 |
| O1 | 0.87602 | 0.37148 | 0.59894 |
| O5 | 0.32121 | 0.90698 | 0.86343 |
| O9 | 0.84561 | 0.48586 | 0.48898 |
| O13 | 0.16017 | 0.0168 | 0.8619 |
| O17 | 0.65181 | 0.52177 | 0.5335 |
| O21 | 0.0299 | 0.39811 | 0.54322 |
| O25 | 0.29999 | 0.62728 | 0.5097 |
| O29 | 0.99308 | 0.04209 | 0.90028 |
| O33 | 0.46315 | 0.57564 | 0.57123 |
| O37 | 0.49995 | 0.92372 | 0.9252 |
| H1 | 0.81897 | 0.46382 | 0.43912 |
| H5 | 0.67785 | 0.5628 | 0.50385 |
| H9 | 0.66161 | 0.72965 | 0.79353 |
| H13 | 0.20018 | 0.31345 | 0.5993 |
| H17 | 0.91531 | 0.2319 | 0.68518 |
| H21 | 0.32241 | 0.80742 | 0.73575 |
| H25 | 0.04688 | 0.86728 | 0.21109 |
| H29 | 0.80258 | 0.8949 | 0.23745 |
| H33 | 0.54787 | 0.8485 | 0.1778 |
| H37 | 0.31663 | 0.77609 | 0.11714 |
| N1 | 0.58429 | 0.75718 | 0.78974 |
| N5 | 0.57668 | 0.81099 | 0.8419 |
| N9 | 0.18626 | 0.22128 | 0.66862 |
| N13 | 0.14658 | 0.28087 | 0.625 |
| C1 | −2.2E−4 | 0.23807 | 0.67223 |
| C5 | 0.97444 | 0.3595 | 0.58539 |
| C9 | 0.38451 | 0.62499 | 0.56383 |
| C13 | 0.06598 | 0.05092 | 0.85582 |
| C17 | 0.42659 | 0.89376 | 0.87431 |
| C21 | 0.40959 | 0.79866 | 0.76114 |
| C25 | 0.09705 | 0.19393 | 0.69839 |
| C29 | 0.03478 | 0.2937 | 0.62543 |
| C33 | 0.46899 | 0.83654 | 0.82503 |
| C37 | 0.48692 | 0.7471 | 0.73872 |
| C41 | 0.88589 | 0.8682 | 0.2474 |
| C45 | 0.96303 | 0.89247 | 0.20561 |
| C49 | 0.47802 | 0.8084 | 0.1784 |
| C53 | 0.38857 | 0.81489 | 0.12221 |
| Al5 | 0 | 0.5 | 0.5 |
| Al7 | 0.5 | 0.5 | 0.5 |

### EXAMPLE REFERENCES

(1) Mekonnen, M. M.; Hoekstra, A. Y. Four Billion People Facing Severe Water Scarcity. Sci. Adv. 2016, 2 (2), el500323.
(2) WWAP (World Water Assessment Programme) The United Nations World Water Development Report 2018: Nature-Based Solutions for Water; UNESCO: Paris, 2018.
(3) Wahlgren, R. V. Atmospheric Water Vapour Processor Designs for Potable Water Production: A Review. Water Res: 2001, 35 (1), 1-22.
(4) Hanikel, N.; Prévot, M. S.; Yaghi, O. M. MOF Water Harvesters. Nat. Nanotechnol. 2020, 15 (5), 348-355.
(5) Eddaoudi, M.; Kim, J.; Rosi, N.; Vodak, D.; Wachter, J.; O'Keeffe, M.; Yaghi, O. M. Systematic Design of Pore Size and Functionality in Isoreticular MOFs and Their Application in Methane Storage, Science 2002, 295 (5554), 469-472.
(6) Yaghi, O. M.; O'Keeffe, M.; Ockwig, N. W.; Chae, H. K.; Eddaoudi, M.; Kim, J. Reticular Synthesis and the Design of New Materials. Nature 2003, 423 (6941), 705-714.
(7) Furukawa, H.; Cordova, K. E.; O'Keeffe, M.; Yaghi, O. M. The Chemistry and Applications of Metal-Organic Frameworks. Science 2013, 341 (6149), 1230444-1230444.
(8) Furukawa, H.; Gándara, F.; Zhang, Y.-B.; Jiang. J.; Queen, W. L.; Hudson, M. R.; Yaghi, O. M. Water Adsorption in Porous Metal-Organic Frameworks and Related Materials. J. Am. Chem. Soc. 2014, 136 (11), 4369-4381.
(9) Kim, H.; Yang, S.; Rao, S. R.; Narayanan, S.; Kapustin, E. A.; Furukawa, H; Umans, A. S.; Yaghi, O. M.; Wang, E. N. Water Harvesting from Air with Metal-Organic Frameworks Powered by Natural Sunlight. Science 2017, 356 (6336), 430-434.
(10) Kim, H; Rao, S. R.; Kapustin, E. A.; Zhao, L.; Yang, S.; Yaghi, O. M.; Wang, E. N. Adsorption-Based Atmospheric Water Harvesting Device for Arid Climates. Nat. Commun. 2018, 9 (1), 1191.
(11) Fathieh, F.; Kalmutzki, M. J.; Kapustin, E. A.; Waller, P. J; Yang, J.; Yaghi, O. M. Practical Water Production from Desert Air. Sci. Adv. 2018, 4 (6), eaat3198.
(12) Hanikel, N.; Prévot, M. S.; Fathieh, F.; Kapustin, E. A.; Lyu, H.; Wang, H.; Diercks, N. J.; Glover, T. G.; Yaghi, O. M. Rapid Cycling and Exceptional Yield in a Metal-Organic Framework Water Harvester. ACS Cent. Sci. 2019, 5 (10), 1699-1706.
(13) Yilmaz, G.; Meng, F. L.; Lu, W.; Abed, J.; Peh. C. K. N.; Gao, M.; Sargent, E. H.; Ho, G. W. Autonomous Atmospheric Water Seeping MOF Matrix. Sci. Adv. 2020, 6 (42), 1-9.
(14) Almassad, H. A.; Abaza, R. I.; Siwwan, L.; Al-Maythalony, B.; Cordova, K. E. Environmentally Adaptive MOF-Based Device Enables Continuous Self-Optimizing Atmospheric Water Harvesting. Nat. Commun. 2022, 13 (1).
(15) Hanikel, N.; Pei, X.; Chheda, S.; Lyu, H.; Jeong, W.; Sauer, J.; Gagliardi, L.; Yaghi, O. M. Evolution of Water Structures in Metal-Organic Frameworks for Improved Atmospheric Water Harvesting. Science 2021, 374 (6566), 454-459.
(16) Loiseau, T.; Mellot-Draznieks, C.; Muguerra, H.; Férey, G.; Haouas, M.; Taulelle, F. Hydrothermal Synthesis and Crystal Structure of a New Three-Dimensional Aluminum-Organic Framework MIL-69 with 2,6-Naphthalenedicarboxylate (Ndc), Al(OH)(Ndc)·H2O. Comptes Rendus Chim. 2005, 8 (3-4), 765-772.
(17) Senkovska, I. et al, New Highly Porous Aluminium Based Metal-Organic Frameworks: Al(OH)(Ndc) (Ndc=2,6-Naphthalene Dicarboxylate) and Al(OH)(Bpdc) (Bpdc=4,4′-Biphenyl Dicarboxylate). Microporous Mesoporous Mater. 2009, 122 (1-3), 93-98.
(18) Bloch, E. D.; Britt, D; Lee, C.; Doonan, C. J.; Uribe-Romo, F. J.; Furukawa, H.; Long, J. R; Yaghi, O. M. Metal Insertion in a Microporous Metal-Organic Framework Lined with 2,2′-Bipyridine. J. Am. Chem. Soc. 2010, 132 (41), 14382-14384.
(19) Krüger, M.; Reinsch, H.; Inge, A. K.; Stock, N. Effect of Partial Linker Fluorination and Linker Extension on Structure and Properties of the Al-MOF CAU-10. Microporous Mesoporous Mater. 2017, 249 (2), 128-136.
(20) Kalmutzki, M. J.; Diercks, C. S.; Yaghi, O. M. Metal-Organic Frameworks for Water Harvesting from Air. Adv. Mater. 2018, 30 (37), 1704304.
(21) Liu, X.; Wang, X.; Kapteijn, F. Water and Metal-Organic Frameworks: From Interaction toward Utilization. Chem. Rev. 2020, 120 (16). 8303-8377.
(22) Küsgens, P.; Rose, M.; Senkovska, I.; Fröde, H.; Henschel, A.; Siegle, S.; Kaskel, S. Characterization of Metal-Organic Frameworks by Water Adsorption. Microporous Mesoporous Mater. 2009, 120 (3), 325-330.
(23) Brun, P.; Zimmermann, N. E.; Hari, C.; Pellissier, L.; Karger, D. N. Global Climate-Related Predictors at Kilometre Resolution for the Past and Future Earth System Science Data Discussions. Earth Surf. Sci. Data 2022, No. June 1-44.
(24) Vicente-Serrano, S. M. et al, Recent Changes of Relative Humidity: Regional Connections with Land and Ocean Processes. Earth Syst. Dyn. 2018, 9 (2), 915-937.
(25) Zheng, Z.; Hanikel, N.; Lyu, H.; Yaghi, O. M. Broadly Tunable Atmospheric Water Harvesting in Multivariate Metal-Organic Frameworks. J. Am. Chem. Soc. 2022.

### SUPPLEMENTAL REFERENCES

[1] Bruker AXS Inc. 2018, APEX3.
[2] Bruker AXS Inc. 2018, SAINT.
[3] Bruker AXS Inc. 2016, SADABS.
[4] Sheldrick, G. M. SHELXT—Integrated Space-Group and Crystal-Structure Determination. Acta Crystallogr. A 2015, 71, 3-8.
[5] Sheldrick, G. M. Crystal Structure Refinement with SHELXL. Acta Crystallogr. C 2015, 71, 3-8.
[6] Dolomanov, O. V., Bourhis, L. J., Gildea, R. J., Howard, J. A. K., Puschmann, H. OLEX2: A Complete Structure Solution, Refinement and Analysis Program. J. Appl. Crystallogr. 42 2009, 339-341.
[7] Kresse, G.; Furthmüller, J. Efficiency of Ab-Initio Total Energy Calculations for Metals and Semiconductors Using a Plane-Wave Basis Set. Comput. Mater. Sci. 1996, 6, 15-50.
[8] Perdew, J. P.; Burke, K.; Emzerhof, M. Generalized Gradient Approximation Made Simple. Phys. Rev. Lett. 1996, 77, 3865-3868.
[9] Grimmea, S.; Antony, J., Ehrlich, S.; Krieg, H. A Consistent and Accurate Ab initio Parametrization of Density Functional Dispersion Correction (DFT-D) for the 94 Elements H—Pu. J. Chem. Phys. 2010, 132, 154104.
[10] Siepmann, J. I.; Martin, M. G.; Chen, B.; Wick, C.; Stubbs, J. M.; Potoff, J. J.; Eggimann, B. L.; McGrath, M. J.; Zhao, X. S.; Anderson, K. E.; Rafferty, J. L.; Rai, N.; Maerzke, K. A.; Keasler, S. J.; Bai, P.; Fetisov, E. O.; Shah, M. S.; Chen, Q. P.; DeJaco, R. F.; Chen, J. L.; Xue, B.; Bunner. C.; Sun, Y. Z. S.; Josephson, T. R. Monte Carlo for Complex Chemical Systems-Minnesota, version 20.2; University of Minnesota: Minneapolis, MN, 2020.
[11] Chheda, S.; Jeong, W.; Hanikel, N.; Gagliardi, L.; Siepmann, J. I. Monte Carlo Simulations of Water Adsorption in AlO(μ₂-OH) Rod-Based Metal-Organic Frameworks, in preparation.
[12] Maerzke, K. A., Schultz, N. E.; Ross, R. B., Siepmann, J. I. TraPPE-UA force field for acrylates and Monte Carlo simulations for their mixtures with Alkanes and alcohols. J. Phys. Chem. B 2009, 113, 6415-6425.
[13] (a) Wittig, G., Geissler, G., Zur Reaktionsweise des Pentaphenyl-Phosphors und Einiger Derivate. Justus Liebigs Ann. Chem. 1953, 580, 44-57. (b) Maercker, A. The Wittig Reaction. In Organic Reactions, (Ed.). 2011, https://doi.org/10.1002/0471264180.or014.03.

1.-15. (canceled)

16. A metal-organic framework (MOF) composition comprising a metal complexed with an organic linker.

17. The MOF composition of claim 16, wherein the organic linker is a compound listed in Table 2, a compound listed in Table 3, or a compound according to Formula (II): 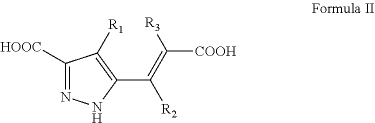
wherein R₁ is H, NH₂ or OH; R₂ is H, NH₂ or OH; and R₃ is H, NH₂ or OH.

18. The MOF composition of claim 17, wherein the organic linker is a compound listed in Table 2.

19. The MOF composition of claim 18, wherein the organic linker is

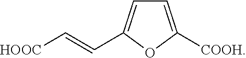 [SMILES: O=C(O)/C=C/c1ccc(C(=O)O)o1]

20. The MOF composition of claim 18, wherein the organic linker is

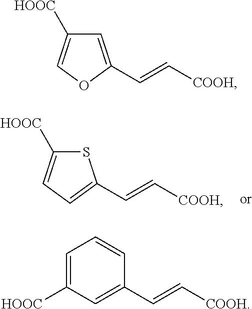

21. The MOF composition of claim 17, wherein the organic linker is a compound listed in Table 3.

22. The MOF composition of claim 21, wherein the organic linker is

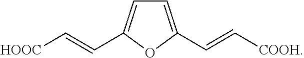 [SMILES: O=C(O)/C=C/c1ccc(/C=C/C(=O)O)o1]

23. The MOF composition of claim 21, wherein the organic linker is

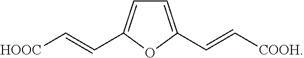 [SMILES: O=C(O)/C=C/c1ccc(/C=C/C(=O)O)o1]

24. The MOF composition of claim 17, wherein the organic linker is a compound according to Formula (II): 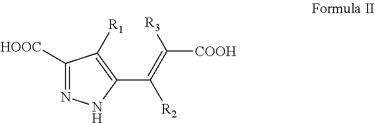
wherein R₁ is H, NH₂ or OH; R₂ is H, NH₂ or OH; and R₃ is H, NH₂ or OH.

25. The MOF composition of claim 24, wherein the R₁ is H; the R₂ is H; and the R₃ is H.

26. The MOF composition of claim 16, wherein the metal is a metal ion selected from Li⁺, Na⁺, K⁺, Rb⁺, Cs⁺, Be²⁺, Mg²⁺, Ca²⁺, Sr²⁺, Ba²⁺, Sc³⁺, Sc²⁺, Sc⁺, Y³⁺, Y²⁺, Y⁺, Ti⁴⁺, Ti³⁺, Ti²⁺, Zr⁴⁺, Zr³⁺, Zr²⁺, Hf⁴⁺, Hf³⁺, V⁵⁺, V⁴⁺, V³⁺, V²⁺, Nb⁵⁺, Nb⁴⁺, Nb³⁺, Nb²⁺, Ta⁵⁺, Ta⁴⁺, Ta³⁺, Ta²⁺, Cr⁶⁺, Cr⁵⁺, Cr⁴⁺, Cr³⁺, Cr²⁺, Cr⁺, Cr, Mo⁶⁺, Mo⁵⁺, Mo⁴⁺, Mo³⁺, Mo²⁺, Mo⁺, Mo, W⁶⁺, W⁵⁺, W⁴⁺, W³⁺, W²⁺, W⁺, W, Mn⁷⁺, Mn⁶⁺, Mn⁵⁺, Mn⁴⁺, Mn³⁺, Mn²⁺, Mn⁺, Re⁷⁺, Re⁶⁺, Re⁵⁺, Re⁴⁺, Re³⁺, Re²⁺, Re⁺, Re, Fe⁶⁺, Fe⁴⁺, Fe³⁺, Fe²⁺, Fe⁺, Fe, Ru⁸⁺, Ru⁷⁺, Ru⁶⁺, Ru⁴⁺, Ru³⁺, Ru²⁺, Os⁸⁺, Os⁷⁺, Os⁶⁺, Os⁵⁺, Os⁴⁺, Os³⁺, Os²⁺, Os⁺, Os, Co⁵⁺, Co⁴⁺, Co³⁺, Co²⁺, Co⁺, Rh⁶⁺, Rh⁵⁺, Rh⁴⁺, Rh³⁺, Rh²⁺, Rh⁺, Ir⁶⁺, Ir⁵⁺, Ir⁴⁺, Ir³⁺, Ir²⁺, Ir⁺, Ir, Ni³⁺, Ni²⁺, Ni⁺, Ni, Pd⁶⁺, Pd⁴⁺, Pd²⁺, Pd⁺, Pd, Pt⁶⁺, Pt⁵⁺, Pt⁴⁺, Pt³⁺, Pt²⁺, Pt⁺, Cu⁴⁺, Cu³⁺, Cu²⁺, Cu⁺, Ag³⁺, Ag²⁺, Ag⁺, Au⁵⁺, Au⁴⁺, Au³⁺, Au²⁺, Au⁺, Zn²⁺, Zn⁺, Zn, Cd²⁺, Cd⁺, Hg⁴⁺, Hg²⁺, Hg⁺, B³⁺, B²⁺, B⁺, Al³⁺, Al²⁺, Al⁺, Ga³⁺, Ga²⁺, Ga⁺, In³⁺, In²⁺, In¹⁺, Tl³⁺, Tl⁺, Si⁴⁺, Si³⁺, Si²⁺, Si⁺, Ge⁴⁺, Ge³⁺, Ge²⁺, Ge⁺, Ge, Sn⁴⁺, Sn²⁺, Pb⁴⁺, Pb²⁺, As⁵⁺, As³⁺, As²⁺, As⁺, Sb⁵⁺, Sb³⁺, Bi⁵⁺, Bi³⁺, Te⁶⁺, Te⁵⁺, Te⁴⁺, Te²⁺, La³⁺, La²⁺, Ce⁴⁺, Ce³⁺, Ce²⁺, Pr⁴⁺, Pr³⁺, Pr²⁺, Nd³⁺, Nd²⁺, Sm³⁺, Sm²⁺, Eu³⁺, Eu²⁺, Gd³⁺, Gd²⁺, Gd⁺, Tb⁴⁺, Tb³⁺, Tb²⁺, Tb⁺, Db³⁺, Db²⁺, Ho³⁺, Er³⁺, Tm⁴⁺, Tm³⁺, Tm²⁺, Yb³⁺, Yb²⁺, Lu³⁺, and combinations thereof, including any complexes which contain the metals or metal ions listed above, as well as any corresponding metal salt counter-anions.

27. The MOF composition of claim 26, wherein the metal is selected from Al³⁺, Sc³⁺, Y³⁺, Cr³⁺, Mn³⁺, Fe³⁺, Ga³⁺, La³⁺, Ce³⁺, Pr³⁺, Nd³⁺, Sm³⁺, Eu³⁺, Gd³⁺, Tb³⁺, Ho³⁺, Er³⁺, Tm³⁺, Yb³⁺, Lu³⁺, and combinations thereof.

28. The MOF composition of claim 26, wherein the metal is selected from Al³⁺, Cr³⁺, Mn³⁺, Fe³⁺, Ga³⁺, La³⁺, and Ce³⁺.

29. The MOF composition of claim 26, wherein the metal is Al³⁺.

30. The MOF composition of claim 16, which comprises repeating cores,
wherein the cores comprise secondary building units connected to the organic linker,
wherein the secondary building units comprise the metal, and
wherein the secondary building units are connected to the organic linker through the oxygen atoms of the carboxylate groups in the organic linker.

31. The MOF composition of claim 30, wherein the secondary building units comprise AlO₆.

32. A method of making the MOF composition of claim 16, comprising complexing the metal with the organic linker to form the MOF composition.

33. A method of using the MOF composition of claim 16, comprising absorbing water in the MOF composition.
